(19) United States
(12) Patent Application Publication
(10) Pub. No.: US 2004/0067868 A1
(43) Pub. Date: Apr. 8, 2004

(54) Process for preparing a detergent tablet

(76) Inventors: Ralf Wiedemann, Griesheim (DE); Marcus Guzmann, Leimen (DE)

Correspondence Address: Norris McLaughlin & Marcus, 30th Floor, 220 East 42nd Street, New York, NY, 10017, US

(21) Appl. No.: 10/432,764

(22) PCT Filed: Nov. 8, 2001
(86) PCT No.: PCT/GB01/04967

(30) Foreign Application Priority Data
Nov. 29, 2000 (GB) 0029095.7

(51) Int. Cl. C11D 17/00

(52) U.S. Cl. 510/447

(57) ABSTRACT

The invention provides a process for preparing a detergent tablet having at least one layer and at least one cavity in at least one surface of the tablet holding at least one pre-shaped insert therein, the process including the steps of delivering a cushioning material to the upper surface of the tablet or into the cavity and delivering a pre-shaped insert on top of the cushioning material.

A process for preparing a detergent tablet The present invention relates to a process for preparing a detergent tablet.

In recent years detergent tablets have become very popular, mainly because of ease of dosing, for example, in a dishwashing machine or washing machine for laundry.

Only recently, tablets have become available comprising a cavity in one surface thereof filled with a composition or pre-shaped insert containing specific ingredients to be separated from the remainder of ingredients of the tablet and/or to become effective in specific phases of the dishwashing or washing cycle. Such products are, for example, described in WO99/06522 and WO00/06684.

Usually, the layer(s) of a detergent tablet are formed by compression of usually particulate material filled into the die of a tablet press machine. The cavity is usually formed by using any appropriately shaped upper punch having a protrusion corresponding to the shape of the cavity. The pre-shaped insert is then affixed to the cavity with the help of an adhesive substance.

Recently, tablet press machines have become commercially available having a system capable of delivering pre-shaped inserts to the tabletting press at any desired intermediate point during the overall pressing process. With these machines it is possible to press tablets with cavities while incorporating pre-shaped inserts in the same press machine.

Known processes making use of this new type of machines are characterised by the following steps:

i. one or more compositions are delivered into the die of the press machine;

ii. the compositions are optionally compressed with an upper punch having a central protrusion to create a cavity in their upper surface;

iii. a pre-shaped insert is delivered onto the upper surface of the composition(s). In case a cavity has been created in the former step they are delivered to such cavity;

iv. the one or more compositions and the pre-shaped insert are compressed in a final compression step.

When following the above described process, the adhesion of the pre-shaped insert to the tablet's main body is guaranteed by the last compression step that forces the material of the tablet's main body to tightly embrace the pre-shaped insert.

One possible embodiment of a process as shortly described above is given in more detail now. The process makes use of a new type of press machines with a two-part upper punch having a central portion thereof movable with respect to the remainder of the punch.

This embodiment comprises a first step, after the filling of the die with the material for the tablet's main body, in which the upper punch (with the central part in a protruding position) is used to create a void space (a cavity) in the powder contained in the die of the press machine but without substantially compressing the powder in the die. The cavity created by the punch helps ensure that the pre-shaped insert later delivered will be placed in the desired spatial relationship to the tablet.

In a second step, the punch is raised and the pre-shaped insert is delivered into the cavity of the tablet.

In a third step, the upper punch is lowered once again, with the central portion at least partially retracted in order to avoid exerting substantial forces on the pre-shaped insert. When lowering the punch again, final compression of the tablet takes place. During the final compression of the tablet, the material of the uppermost layer will not only be compressed in a vertical direction, but the material will also extend horizontally into the cavity to tightly embrace the pre-shaped insert therein.

According to a second embodiment of a process as shortly described above the manufacturing process will comprise the following steps:

In a first step, after the filling of the die with the material for the tablet's main body, the pre-shaped insert is delivered to the material's upper surface.

In a second step the upper punch is lowered to compress the tablet and the insert.

During the final compression of the tablet, the material of the uppermost layer will not only be compressed in a vertical direction, but the material will also extend horizontally into the cavity to tightly embrace the pre-shaped insert therein. In this execution the cavity hosting the insert is formed throughout the final compression step.

These embodiments (as well as others presently performed with the new type of press machine) present, however, a problem which consists in that, although exertion of substantial forces from the upper punch itself is avoided, this compression step exerted not only onto the tablet's main body but also on the already pre-shaped insert very often results in broken inserts.

As this is economically highly undesired, the present invention seeks to find a solution for this problem.

Very surprisingly, it has now been discovered that delivering a cushioning material between the tablet's main body and the pre-shaped insert or inserts (preferably before dropping the pre-shaped insert(s) therein) results in significantly less breakage of those inserts in the final compression step of the tablet. Without wishing to be bound to any theory, it is hypothesised that the cushioning material seems to be able to absorb and/or equally distribute the forces exerted onto the insert(s) during the final compression step, possibly by spreading the cushioning material throughout the interface of the insert and the cavity.

Thus, the invention is directed to a process for preparing a detergent tablet, having at least one layer and at least one cavity in at least one surface of the tablet holding at least one pre-shaped insert therein, in a tablet press machine comprising a die, a lower punch therein and an upper punch to be lowered towards the lower punch in the die, the process comprising the following steps:

a) filling the die with at least one composition to form the at least one layer of the tablet;

b) optionally forming a cavity in the upper surface of the composition with or without simultaneous substantial compression thereof;

c) delivering a cushioning material to the upper surface of the composition or into the cavity formed in step (b), respectively;

d) delivering at least one pre-shaped insert on top of the cushioning material;

e) compressing the one or more compositions and the pre-shaped insert(s) in a final compression step.

According to a first alternative of the invention, step (c) is performed immediately after step (a) without forming any cavity in the upper surface of the composition.

According to another alternative of the invention, the cavity in step (b) is formed in the upper surface of the composition without any simultaneous substantial compression thereof.

According to a preferred embodiment of the invention the upper punch comprises at least one portion being relatively movable with respect to the remainder of the upper punch, wherein the cavity forming step (b) is performed with the movable portion of the upper punch protruding from the surface thereof and the compression step (e) is performed with the movable portion of the upper punch being retracted to at least the surface thereof.

In a preferred embodiment, the inventive process is applied to a multi-layer tablet wherein, in step (a), such multi-layer tablet is formed by sequentially filling compositions for the respective layers into the die and optionally compressing such compositions after each filling step.

In a most preferred embodiment of the invention, a first composition is filled into the die; the first composition is compressed to form a first layer; and a second composition is filled onto the compressed first layer to form a second layer of the tablet.

As non-limiting examples the pre-shaped insert(s) used in a process according to the invention can be made by a compression technology (e.g. compression in a tablet press, injection moulding) or by non-compression technologies (e.g. casting), which also includes capsules (e.g. gelatine capsules). Optionally, the pre-shaped insert(s) is/are fully or partially surrounded by a coating (e.g. film forming cellulose, film forming acrylates, gelatine, waxes).

Preferably, the cushioning material is a meltable material to be dosed in its molten state and being able to harden over the time.

Preferably, the cushioning material is a material soluble or dispersible in water or alkaline aqueous solutions.

As non-limiting examples the cushioning material can be selected from the group consisting of polymeric material (e.g. polyvinyl pyrrolidone, polyethylene glycol), carboxylic acids (e.g. fatty acids), polyols (e.g. 1,10 decanediol), sugar derivatives (e.g. sorbitol), and waxes (e.g. paraffin).

Preferably, the cushioning material is dosed into a central position on the uppermost layer of or into a central position of the cavity, allowing equal spreading of the material throughout the interface between the insert and the cavity during the final compression step.

According to a further aspect of the present invention there is provided a detergent tablet having at least one layer and at least one cavity in at least one surface of the tablet holding at least one pre-shaped insert therein, the tablet comprising:

a) at least one composition to form the at least one layer of the tablet;

b) a cushioning material; and

c) at least one pre-shaped insert,

the cushioning material located adjacent the pre-shaped insert(s).

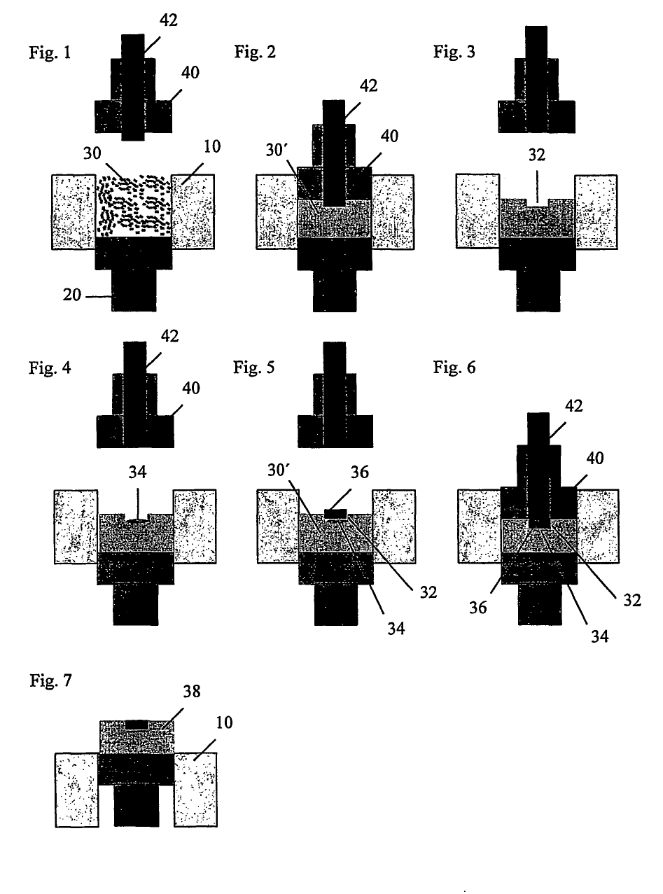

A preferred embodiment of the inventive process will now be described in the following example. The accompanying drawings (FIGS. 1 to 7), intended to further illustrate the process, show the die of a tablet press machine in different stages of the inventive process.

FIG. 1 shows a die 10 with a lower punch 20 in a position to receive a composition 30 to be pressed to a tablet. A two-part upper punch 40 comprising a central movable portion 42 is shown in a raised position. Thus FIG. 1 reflects the stage after step (a) of the inventive process.

In FIG. 2, the upper punch 40 is lowered to pre-compress composition 30 in the die. Simultaneously or subsequently, the central portion 42 of the upper punch 40 is moved to protrude from the surface thereof in order to create a cavity 32 in the pre-compressed tablet 30′. Thus, FIG. 2 reflects the stage after step (b) of the inventive process.

In FIG. 3, the upper punch 40 is raised, with the central movable portion 42 being retracted.

In FIG. 4, a cushioning material 34 is delivered into the cavity 32 of the pre-compressed composition 30′, preferably into a central portion thereof. This corresponds to step (c).

In FIG. 5, a pre-shaped insert 36 is dropped into the cavity 32 onto cushioning material 34. Thus, FIG. 5 reflects the stage after step (d) of the inventive process.

In FIG. 6, which reflects step (e), the upper punch 40, with retracted central portion 42, is lowered once again to conduct the final compression step for the tablet. Preferably, the central portion 42 is adjusted either to form a flat surface with the punch 40 (as shown in the drawing) or in a position to hold the pre-shaped insert 36 in its position in the cavity 32 (or to even slightly press it into that cavity) in order to avoid the insert to escape therefrom. In the final compression step, the cushioning material 34 is spread within the cavity 32 around the pre-shaped insert 36, thus protecting it from destructive forces exerted by the final compression step.

In FIG. 7 the final tablet 38 is ejected from the die 10.

Use of the inventive process results in significantly less breakage of the pre-shaped insert(s) and firm adhesion thereof in the cavity.

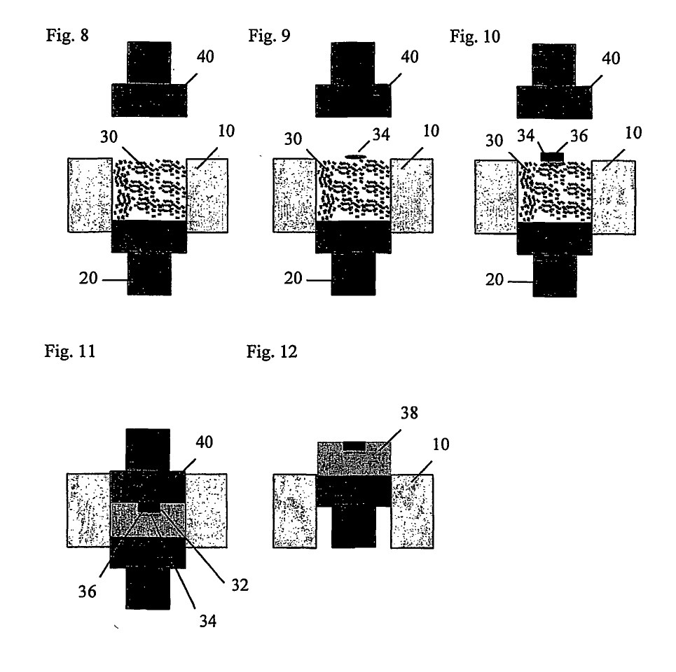

Another embodiment of the inventive process according to the second execution will now be described in the following example. The accompanying drawings (FIGS. 8 to 12), intended to further illustrate the process, show the die of a tablet press machine in different stages of the inventive process.

FIG. 8 shows a die 10 with a lower punch 20 in a position to receive material 30 to be pressed to a tablet. An upper punch 40 is shown in a raised position. Thus FIG. 8 reflects the stage after step (a) of the inventive process.

In FIG. 9, a cushioning material 0.34 is delivered onto the composition 30, optionally onto a slightly pre-compressed and thus levelled composition, preferably into a central portion thereof. This corresponds to step (c).

In FIG. 10, a pre-shaped insert 36 is dropped onto the cushioning material 34. Thus, FIG. 10 reflects the stage after step (c) of the inventive process.

In FIG. 11, which reflects step (e), the upper punch 40 is lowered to conduct the final compression step for the tablet. The cushioning material 34 is spread within the formed cavity 32 around the pre-shaped insert 36, thus protecting it from destructive forces exerted by the final compression step.

In FIG. 12 the final tablet 38 is ejected from the die 10.

Use of the inventive process results in significantly less breakage of the pre-shaped insert and firm adhesion thereof in the cavity. Additionally the process allows more precise positioning of the pre-shaped insert due to the adhesive capabilities of the cushioning material.

1. A process for preparing a detergent tablet, having at least one layer and at least one cavity in at least one surface of the tablet holding at least one pre-shaped insert therein, in a tablet press machine comprising a die, a lower punch therein and an upper punch to be lowered towards the lower punch in the die, the process comprising the following steps:
a) filling the die with at least one composition to form the at least one layer of the tablet;
b) optionally forming a cavity in the upper surface of the composition with or without simultaneous substantial compression thereof;
c) delivering a cushioning material to the upper surface of the composition or into the cavity formed in step (b), respectively;
d) delivering at least one pre-shaped insert on top of the cushioning material; and
e) compressing the one or more compositions and the pre-shaped insert(s) in a final compression step.

2. Process according to claim 1, wherein step (c) is performed immediately after step (a) without forming any cavity in the upper surface of the composition.

3. Process according to claim 1, wherein, in step (b), a cavity is formed in the upper surface of the composition without any simultaneous substantial compression thereof.

4. Process according to claim 1 or 3, wherein the upper punch comprises at least one portion being relatively movable with respect to the remainder of the upper punch wherein the cavity forming step (b) is performed with the movable portion of the upper punch protruding from the surface thereof and the compression step (e) is performed with the movable portion of the upper punch being retracted to at least the surface thereof.

5. Process according to any of the preceding claims wherein, in step (a), a multi-layer tablet is formed by sequentially filling compositions for the respective layers into the die and optionally compressing such compositions after each filling step.

6. Process according to claim 5 wherein a first composition is filled into the die; the first composition is compressed to form a first layer; and a second composition is filled onto the compressed first layer to form a second layer of the tablet.

7. Process according to any one of the preceding claims wherein the cushioning material is a meltable material to be dosed in its molten state and being able to harden over the time.

8. Process according to claim 7 wherein the cushioning material is a material soluble or dispersible in water or alkaline aqueous solutions.

9. Process according to claim 7 or 8 wherein the cushioning material is selected from the group consisting of polymeric material (e.g. polyvinyl pyrrolidone, polyethylene glycol), carboxylic acids e.g. fatty acids), polyols (e.g. 1,10 decanediol), sugar derivatives (e.g. sorbitol), and waxes (e.g. paraffin).

10. Process according to any of the preceding claims, wherein the cushioning material is dosed into a central position on the uppermost layer or into a central position of the cavity, allowing equal spreading of the material throughout the interface between the insert and the cavity during the final compression step.
